(19) United States
(12) Patent Application Publication
(10) Pub. No.: US 2026/0044656 A1
(43) Pub. Date: Feb. 12, 2026

(54) TIMING-VIOLATION SOFTWARE PHYSICAL UNCLONABLE FUNCTION CIRCUIT

(71) Applicant: Wenzhou University, Zhejiang (CN)

(72) Inventors: Pengjun WANG, Zhejiang (CN); Ziyang Zheng, Zhejiang (CN); Yijian SHI, Zhejiang (CN); Gang LI, Zhejiang (CN); Bo CHEN, Zhejiang (CN)

(73) Assignee: Wenzhou University, Zhejiang (CN)

(21) Appl. No.: 19/277,313

(22) Filed: Jul. 22, 2025

(30) Foreign Application Priority Data
Aug. 8, 2024 (CN) 202411082153.5

(51) Int. Cl. G06F 30/3312; G06F 119/12

(52) U.S. Cl. CPC G06F 30/3312; G06F 2119/12

(57) ABSTRACT

A timing-violation software physical unclonable function circuit including combinatorial logic pipeline architecture is provided. The combinatorial logic pipeline architecture serves as a hardware platform. The combinatorial logic pipeline architecture includes an arithmetic operation cell, and the arithmetic operation cell includes a carry lookahead adder for performing add operations. The timing-violation software physical unclonable function circuit generates PUF response outputs by triggering timing violations in the combinatorial logic pipeline architecture.

### CROSS-REFERENCE TO RELATED APPLICATION

This application claims the priority benefit of China application serial no. 202411082153.5, filed on Aug. 8, 2024. The entirety of the above-mentioned patent application is hereby incorporated by reference herein and made a part of this specification.

### TECHNICAL FIELD

The invention relates to software physical unclonable function circuits, in particular to a timing-violation software physical unclonable function circuit.

### DESCRIPTION OF RELATED ART

Nowadays, with the rapid development of the Internet of Things, the information security issue is becoming increasingly prominent. Some hackers and those with malicious intentions attempt to steal, copy or tamper key information, exposing traditional digital keys and identifiers to an ever-serious threat. Physical Unclonable Functions (PUFs), as a chip fingerprint extraction technique, realize secure storage of data and mutual authentication of information by means of process deviations in the integrated circuit manufacturing process and are widely applied to the fields of encryption, equipment authentication and key generation because of their unpredictability and non-replicability.

PUFs are divided into Hardware PUFs (HPUFs) and Software PUFs (SPUFs) according to whether a dedicated hardware circuit is used as an entropy source. The HPUFs are generally integrated into a chip and then embedded in a target circuit, or are realized by configuring a special circuit structure in a programmable device such as a Field Programmable Gate Array (FPGA). The SPUFs use an existing hardware structure as a hardware platform and realize sharing of the hardware structure. The increase in the size of an IoT system leads to the appearance of security protection problems of more and more resource-constrained systems, and traditional HPUFs depending on the dedicated hardware circuit are not applicable anymore, and the demand for the SPUFs is becoming increasingly greater.

In recent years, a software physical unclonable function circuit using path delay information in traditional digital multipliers emerges. In the design of a digital system, the multiplier is one of the typical combinatorial logic structural cells for performing arithmetic operations, and a complex data transmission path affected by input signals is configured in the multiplier. The software physical unclonable function circuit uses a 32-bit multiplier as a hardware platform, input signals of the 32-bit multiplier are used as PUF challenge signals, a transmission path delay in the 32-bit multiplier is used as an entropy source and quantized by a 12-bit time-to-digital converter (TDC), Bit-5 and Bit-6 output by the TDC are used as PUF response outputs of the software PUF, and a lightweight dynamic obfuscation algorithm (DOA) and a secure mutual authentication protocol are adopted to defend against modeling attacks.

Although such a software physical unclonable function circuit has high security and PUF responses are obtained by quantizing the transmission path delay in the 32-bit amplifier without a specially designing a hardware circuit for generating an entropy source, the 12-bit TDC used for quantizing the transmission path delay in the 32-bit multiplier and the DOA realized by hardware occupy a large quantity of hardware overheads; and only two bits output by the 12-bit TDC satisfy indicator requirements of PUF responses, leading to a great waste of hardware resources. In addition, because the internal transmission path and structure of the 32-bit multiplier are complex and the validity of a transmission path needs to be checked before the TDC outputs a quantized value, the quantization process is complex and time-consuming, directly compromising PUF response generation efficiency. Moreover, inevitable stochastic noise in the actual quantization process of the delay path results in low reliability of the software physical unclonable function circuit.

### SUMMARY

The technical issue to be settled by the invention is to provide a timing-violation software physical unclonable function circuit, which has high security, low hardware overheads, high PUF response generation efficiency and high reliability and avoids a waste of hardware resources.

The technical solution adopted by the invention to settle the above technical issue is as follows: a timing-violation software physical unclonable function circuit including combinatorial logic pipeline architecture is provided. The combinatorial logic pipeline architecture serves as a hardware platform. The combinatorial logic pipeline architecture includes an arithmetic operation cell, and the arithmetic operation cell includes a carry lookahead adder for performing add operations. The timing-violation software physical unclonable function circuit generates PUF response outputs by triggering timing violations in the combinatorial logic pipeline architecture.

The combinatorial logic pipeline architecture further includes an input register cell and a sampling register cell; the carry lookahead adder is an m-bit carry lookahead adder, and the m-bit carry lookahead adder has two m-bit addend input ports and a (m+1)-bit addend sum output port; the input register cell is formed by 2 m D flip-flops, each D flip-flop has a signal input port, a signal output port and a clock control port, the signal input ports of the 2 m D flip-flops are used as a 2 m-bit challenge input port of the input register cell, the signal output ports of the 2 m D flip-flops are used as a 2 m-bit output port of the input register cell, the clock control ports of the 2 m D flip-flops are connected, and a connecting terminal is a clock control port of the input register cell; the sampling register cell is formed by (m+1) D flip-flops, each D flip-flop has a signal input port, a signal output port and a clock control port, the signal input ports of the (m+1) D flip-flops are used as a (m+1)-bit input port of the sampling register cell, the signal output ports of the (m+1) D flip-flops are used as a (m+1)-bit output port of the sampling register cell, the clock control ports of the (m+1) D flip-flops are connected, and a connecting terminal is a clock control port of the sampling register cell; and the 2 m-bit output port of the input register cell is correspondingly bit addend sum output port of the m-bit carry lookahead adder is connected to the (m+1)-bit input port of the sampling register cell.

In a case where the timing-violation software physical unclonable function circuit needs to generate a PUF response, a 2 m-bit challenge signal is input to the 2 m-bit challenge input port of the input register cell, and a clock signal lasting for two cycles is synchronously input to the time control port of the input register cell and the clock control port of the sampling register cell, wherein the cycle of the clock signal is 0.5 Tₘₐₓ, and Tₘₐₓ is a maximum path delay time from the 2 m-bit challenge input port of the input register cell to the (m+1)-bit output port of the sampling register cell; at the arrival of a first rising edge of the clock signal, the input register cell, under the control of the clock signal, outputs the 2 m-bit challenge signal input thereto to the two m-bit addend input ports of the m-bit carry lookahead adder by means of the 2 m-bit output port thereof, and the m-bit carry lookahead adder performs an add operation on two m-bit challenge signals input to the two m-bit addend input ports thereof to obtain an (m+1)-bit operation result, which is output to the (m+1)-bit input port of the sampling register cell by means of the (m+1)-bit addend sum output port of the m-bit carry lookahead adder; then, at the arrival of a second rising edge of the clock signal, the sampling register cell, under the control of the clock signal, performs sampling on the (m+1)-bit operation result input to the (m+1)-bit input port thereof; at this moment, because the cycle of the clock signal is too small, a timing violation happens to part of the flip-flops in the sampling register cell, and the flip-flops subjected to the timing violation randomly output 0 or 1 by means of the signal output ports thereof, such that an abnormal (m+1)-bit operation result is output by the (m+1)-bit output port of the sampling register cell and used as an initial PUF response of a software PUF; the most significant bit of a theoretical operation result obtained by performing an add operation on the two m-bit challenge signals input to the two m-bit addend input ports of the m-bit carry lookahead adder is abandoned to obtain an m-bit reference value, the most significant bit of the initial PUF response is abandoned to obtain m-bit data, and different bits between the m-bit data and the m-reference value are counted; if the counting result is an odd number, a final PUF response of the timing-violation software physical unclonable function circuit is 1; otherwise, the final PUF response of the timing-violation software physical unclonable function circuit is 0.

Compared with the prior art, the invention has the following advantages: the combinatorial logic pipeline architecture using the carry lookahead adder as the arithmetic operation cell is adopted as a hardware platform, PUF response outputs are generated by triggering timing violations in the combinatorial logic pipeline architecture without additionally designing and adding any other hardware circuits, and PUF responses capable of representing hardware characteristics may be extracted by triggering timing violations in the combinatorial logic pipeline architecture under the condition of increasing the clock frequency of the existing combinatorial logic pipeline architecture; and the timing-violation software physical unclonable function circuit has higher security, lower hardware overheads, higher working efficiency and better reliability and uniqueness and avoids the waste of hardware resources.

### BRIEF DESCRIPTION OF THE DRAWINGS

FIG. 1A, FIG. 1B, and FIG. 1C are structural diagrams of an input register cell, an arithmetic operation cell and a sampling register cell of a timing-violation software physical unclonable function circuit according to the invention.

FIG. 2 is a circuit architecture diagram of the timing-violation software physical unclonable function circuit according to the invention.

FIG. 3 illustrates a two-dimensional grayscale image of 10,000 responses of one timing-violation software physical unclonable function circuit according to the invention under a normal-temperature and normal-pressure condition.

FIG. 4 illustrates an average grayscale mapping result of output responses of 30 timing-violation software physical unclonable function circuits according to the invention under a normal-temperature and normal-pressure condition.

FIG. 5 illustrates ACF test results of 10,000 responses of one timing-violation software physical unclonable function circuit according to the invention under a normal-temperature and normal-pressure condition.

FIG. 6 is a histogram of the Inter-Hamming distance (Inter-HD) obtained by applying a same group of challenges to 30 timing-violation software physical unclonable function circuits according to the invention under a normal-temperature and normal-pressure condition.

FIG. 7 is a histogram of normalized results of the Intra-Hamming distance obtained by repeatedly applying a same group of challenges to the same timing-violation software physical unclonable function circuit according to the invention under a normal-temperature and normal-pressure condition and the Inter-Hamming distance in FIG. 4.

FIG. 8 is a chart of the predictive accuracy of an ML attack algorithm, which is LR, to five different PUFs under different training sets.

FIG. 9 is a chart of the predictive accuracy of an ML attack algorithm, which is an ANN, to five different PUFs under different training sets.

FIG. 10 is a chart of the predictive accuracy of an ML attack algorithm, which is an SVM, to five different PUFs under different training sets.

FIG. 11 is a chart of the predictive accuracy of an ML attack algorithm, which is a Light GBM, to five different PUFs under different training sets.

### DESCRIPTION OF THE EMBODIMENTS

The invention is described in further detail below in conjunction with accompanying drawings and embodiments.

Embodiment 1: A timing-violation software physical unclonable function circuit adopts a combinatorial logic pipeline architecture using a carry lookahead adder as an arithmetic operation cell and generates PUF response outputs by triggering timing violations in the combinatorial logic pipeline architecture.

In this embodiment, the combinatorial logic pipeline architecture using the carry lookahead adder as the arithmetic operation cell is adopted as a hardware platform, PUF response outputs are generated by triggering timing violations in the combinatorial logic pipeline architecture without additionally designing and adding any other hardware circuits, and PUF responses capable of representing hardware characteristics may be extracted by triggering timing violations in the combinatorial logic pipeline architecture under the condition of increasing the clock frequency of the existing combinatorial logic pipeline architecture. Compared with existing software PUF products, the timing-violation software physical unclonable function circuit has higher security, lower hardware overheads, higher working efficiency and better reliability and uniqueness and avoids the waste of hardware resources.

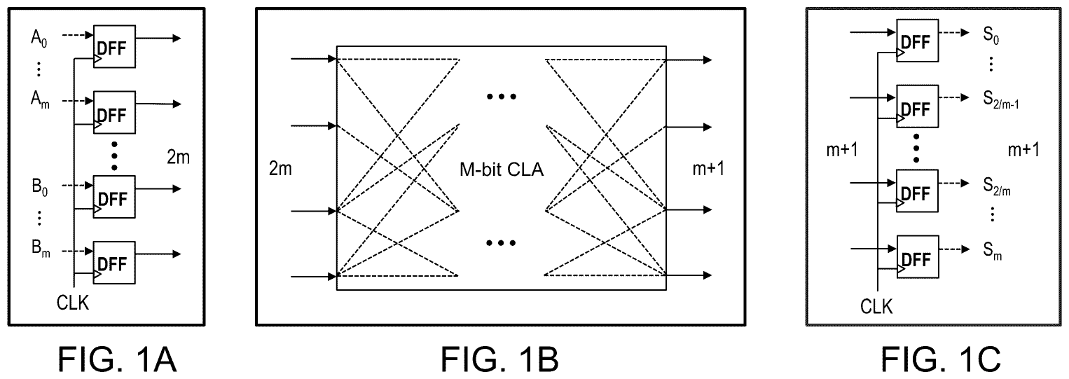

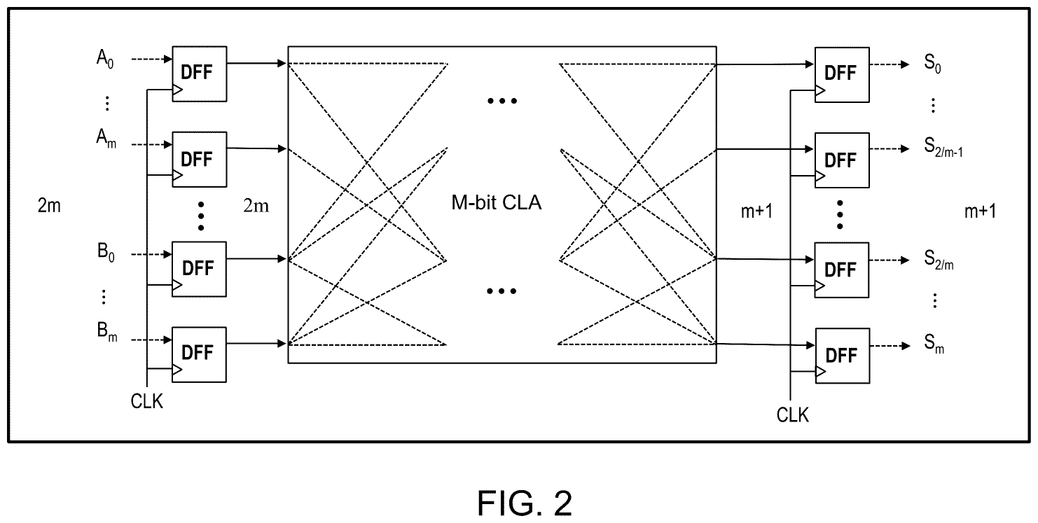

Embodiment 2: This embodiment is basically the same as Embodiment 1. As shown in FIGS. 1 and 2, in this embodiment, the combinatorial logic pipeline architecture includes an input register cell (shown by FIG. 1A), an arithmetic operation cell (shown by FIG. 1B) and a sampling register cell (shown by FIG. 1C); the arithmetic operation cell is a carry lookahead adder for performing add operations, the number of bits of an addend calculated by the carry lookahead adder is m, that is, the carry lookahead adder is an m-bit carry lookahead adder, and the m-bit carry lookahead adder has two m-bit addend input ports and a (m+1)-bit addend sum output port; the input register cell is formed by 2 m D flip-flops, each D flip-flop has a signal input port, a signal output port and a clock control port, the signal input ports of the 2 m D flip-flops are used as a 2 m-bit challenge input port of the input register cell, the signal output ports of the 2 m D flip-flops are used as a 2 m-bit output port of the input register cell, the clock control ports of the 2 m D flip-flops are connected, and a connecting terminal is a clock control port of the input register cell; the sampling register cell is formed by (m+1) D flip-flops, each D flip-flop has a signal input port, a signal output port and a clock control port, the signal input ports of the (m+1) D flip-flops are used as a (m+1)-bit input port of the sampling register cell, the signal output ports of the (m+1) D flip-flops are used as a (m+1)-bit output port of the sampling register cell, the clock control ports of the (m+1) D flip-flops are connected, and a connecting terminal is a clock control port of the sampling register cell; and the 2 m-bit output port of the input register cell is correspondingly connected to the two m-bit addend input ports of the m-bit carry lookahead adder, and the (m+1)-bit addend sum output port of the m-bit carry lookahead adder is connected to the (m+1)-bit input port of the sampling register cell. In a case where the timing-violation software physical unclonable function circuit needs to generate a PUF response, a 2 m-bit challenge signal is input to the 2 m-bit challenge input port of the input register cell, and a clock signal lasting for two cycles is synchronously input to the time control port of the input register cell and the clock control port of the sampling register cell, wherein the cycle of the clock signal is 0.5 Tₘₐₓ, and Tₘₐₓ is a maximum path delay time from the 2 m-bit challenge input port of the input register cell to the (m+1)-bit output port of the sampling register cell (obtained in advance by a test); at the arrival of a first rising edge of the clock signal, the input register cell, under the control of the clock signal, outputs the 2 m-bit challenge signal input thereto to the two m-bit addend input ports of the m-bit carry lookahead adder by means of the 2 m-bit output port thereof, and the m-bit carry lookahead adder performs an add operation on two m-bit challenge signals input to the two m-bit addend input ports thereof to obtain an (m+1)-bit operation result, which is output to the (m+1)-bit input port of the sampling register cell by means of the (m+1)-bit addend sum output port of the m-bit carry lookahead adder; then, at the arrival of a second rising edge of the clock signal, the sampling register cell, under the control of the clock signal, performs sampling on the (m+1)-bit operation result input to the (m+1)-bit input port thereof; at this moment, because the cycle of the clock signal is too small, a timing violation happens to part of the flip-flops in the sampling register cell, and the flip-flops subjected to the timing violation randomly output 0 or 1 by means of the signal output ports thereof, such that an abnormal (m+1)-bit operation result is output by the (m+1)-bit output port of the sampling register cell and used as an initial PUF response of a software PUF; the most significant bit of a theoretical operation result obtained by performing an add operation on the two m-bit challenge signals input to the two m-bit addend input ports of the m-bit carry lookahead adder is abandoned to obtain an m-bit reference value, the most significant bit of the initial PUF response is abandoned to obtain m-bit data, and different bits between the m-bit data and the m-reference value are counted; if the counting result is an odd number, a final PUF response of the timing-violation software physical unclonable function circuit is 1; otherwise, the final PUF response of the timing-violation software physical unclonable function circuit is 0.

In this embodiment, m=32, that is, the arithmetic operation cell is a 32-bit carry lookahead adder, the input register cell is formed by 64 D flip-flops, and the sampling register cell is formed by 33 D flip-flops. It may be obtained, by a post-simulation test, that the maximum path delay time from a 64-bit challenge input port of the input register cell to a 33-bit output port of the sampling register cell is 4.062 ns. The timing-violation software physical unclonable function circuit provided by the invention generates a PUF response specifically by the following steps:
(1) a clock signal lasting for two cycles is synchronously input to the clock control port of the input register cell and the clock control port of the sampling register cell by means of a clock IP core MMCM in an FPGA, wherein the cycle of the clock signal is 2.03 ns; a 64-bit challenge signal 64′h1234ABCDABCD1234 is input to the 64-bit challenge input port of the input register cell; at the arrival of a rising edge of the clock signal within the first cycle, the 64-bit challenge signal 64′h1234ABCDABCD1234 is divided into two 32-bit challenge signals, that is, two 32-bit addends 32′h1234ABCD and 32′hABCD1234 are output to two 32-bit addend input ports of the 32-bit carry lookahead adder in one-to-one correspondence; the 32-bit carry lookahead adder performs an operation on the two 32-bit addends 32′h1234ABCD and 32′hABCD1234 which are input to the two 32-bit addend input ports in one-to-one correspondence, and outputs a 33-bit operation result to a 33-bit input port of the sampling register cell by means of a 33-bit output port thereof; at the arrival of a rising edge of the clock signal within the second cycle, the sampling register cell performs sampling on the 33-bit operation result input to the 33-bit input port thereof; because a timing violation happens to part of the D flip-flops in the sampling register cell at this moment, sampling performed by the sampling register cell on the 33-bit operation result input to the 33-bit input port of the sampling register cell is abnormal, the 33-bit output port of the sampling register cell outputs an abnormal 33-bit operation result 33′h0BE11BD11, and the abnormal 33-bit operation result 33′h0BE11BD11 is fed back to a PC terminal as an initial PUF response of the timing-violation software physical unclonable function circuit provided by the invention;
(2) Matlab of the PC terminal performs an add operation on the two 32-bit addends 32′h1234ABCD and 32′hABCD1234 to obtain a 33-bit theoretical operation value 33′h0BE01BE01;
(3) The most significant bit of the 33-bit theoretical operation value 33′h0BE01BE01 is abandoned to obtain a 32-bit reference value 32′hBE01BE01, and the most significant bit of the initial PUF response is also abandoned to obtain 32-bit data 32′hBE11BD11; an XOR operation is performed on the 32-bit reference value 32′hBE01BE01 and the 32-bit data 32′hBE11BD11 to obtain a 32-bit XOR value 32′h00100310; four bits in the 32-bit data 32′hBE11BD11 are 1, indicating that the number of different bits between the 32-bit reference value 32′hBE01BE01 and the 32-bit data 32′hBE11BD11 is 4, which is an even number, so a PUF response finally generated, under the challenge of the 64-bit challenge signal 64′h1234ABCDABCD1234, by the timing-violation software physical unclonable function circuit provided by the invention is 0.

When the 64-bit challenge signal input to the 64-bit challenge input port of the input register cell changes, the 32-bit addends input to the two 32-bit addend input ports of the 32-bit carry lookahead adder will be changed, thus changing the PUF response finally generated by the timing-violation software physical unclonable function circuit provided by the invention.

In this embodiment, the combinatorial logic pipeline architecture using the 32-bit carry lookahead adder as the arithmetic operation cell is adopted as a hardware platform, and a hardware structure does not need to be additionally configured, such that compared with existing software PUFs realized based on quantization of a path delay in a 32-bit multiplier, the hardware overheads are greatly reduced; when a number of challenges are input, the same number of challenge-response pairs will be generated; and in the process of acquiring a PUF response, the add operation just needs to be performed once, and an initial PUF response of a software PUF may be extracted only by means of two clock cycles, such that the PUF response acquisition process is simplified and efficient. An actual sampling value of the sampling register (the abnormal 33-bit operation result output by the 33-bit output port of the sampling register cell) is used as the initial PUF response of the software PUF, such that bit wastes of PUF responses and instabilities of the responses caused by stochastic noise in the delay time quantization process are avoided, thus improving the reliability of the software PUF. In addition, the final PUF response of the software PUF is subjected to preprocessing of the sampling value (removal of the most significant bit), statistics of the number of different bits of the preprocessed sampling value and the reference value, and odd-even check, such that it is more difficult for attackers to perform a modeling attack to the software PUF, thus improving the security of the software PUF. It thus can be seen that the timing-violation software physical unclonable function circuit provided by the invention has lower hardware overheads, higher working efficiency, better reliability and better security, and is suitable for information protection in the information security field.

A development board NEXYS4 DDR is used to configure the timing-violation software physical unclonable function circuit provided by the invention on an Xilinx XC7A100 T FPGA by means of Vivado, the communication between the timing-violation software physical unclonable function circuit and the FPGA is established by means of Matlab of the PC terminal, a clock IP core MMCM in the FPGA is called to generate a clock control signal, a challenge is generated by Matlab and transmitted to the FPGA, the FPGA feeds back a generated initial PUF response to the PC terminal, and then the initial response is post-processed by Matlab to generate a final software PUF response. The performance of the generated software PUF response is analyzed as follows:

### (1) Randomness

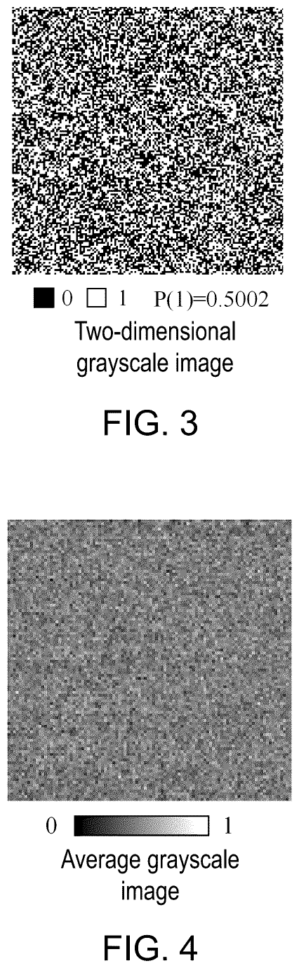

The randomness may be visually measured by observing the distribution of logic 0 and logic 1 of the PUF response. Under a completely stochastic condition, the probability of “0” and the probability of “1” are 0.5. FIG. 3 illustrates a two-dimensional grayscale image of 10,000 responses of one timing-violation software physical unclonable function circuit according to the invention under a normal-temperature and normal-pressure condition. FIG. 4 reflects an average grayscale mapping result of responses of 30 timing-violation software physical unclonable function circuits according to the invention. It may be seen that the overall probability of logic 0 and logic 1 is maintained at about 0.5, the distribution of the PUF responses is random, and there is no obvious logic deviation, indicating that the timing-violation software physical unclonable function circuit provided by the invention has good randomness.

To more strictly and systematically evaluate the randomness of responses of the timing-violation software physical unclonable function circuit provided by the invention, a 106-bit PUF response sequence generated by the timing-violation software physical unclonable function circuit provided by the invention is tested by means of an NIST 800-22 randomness test suite. The 106-bit PUF response sequence is divided into 20 bit streams with a length of 50,000, which are used as inputs of the NIST test. When a tested P-value is greater than 0.01, the bit streams are considered as random, and the confidence is 99%. NIST test results are shown in Table 1.

TABLE 1
NIST test results of PUFs

| | Bit stream | No. of | | Pass |
|---|---|---|---|---|
| Test items | length | Runs | P-value | (%) |
| Frequency | 50000 | 20 | 0.0252 | 20/20 |
| BlockFrequency | 50000 | 20 | 0.1223 | 19/20 |
| CumulativeSums1 | 50000 | 20 | 0.6371 | 20/20 |
| CumulativeSums2 | 50000 | 20 | 0.0351 | 20/20 |
| Runs | 50000 | 20 | 0.2133 | 19/20 |
| LongestRun | 50000 | 20 | 0.3504 | 20/20 |
| Rank | 50000 | 20 | 0.7399 | 20/20 |
| FFT | 50000 | 20 | 0.6371 | 19/20 |
| NonOverlappingTemplate | 50000 | 20 | 0.9642 | 20/20 |
| OverlappingTemplate | 50000 | 20 | 0.2133 | 20/20 |
| ApproximateEntropy | 50000 | 20 | 0.4372 | 20/20 |
| Serial1 | 50000 | 20 | 0.8343 | 20/20 |
| Serial2 | 50000 | 20 | 0.4372 | 20/20 |
| LinearComplexity | 50000 | 20 | 0.7399 | 20/20 |

It may be known, by analyzing Table 1, that the timing-violation software physical unclonable function circuit provided by the invention passes all NIST test items listed, indicating that PUF responses generated by the timing-violation software physical unclonable function circuit provided by the invention have good randomness.

### (2) Unpredictability

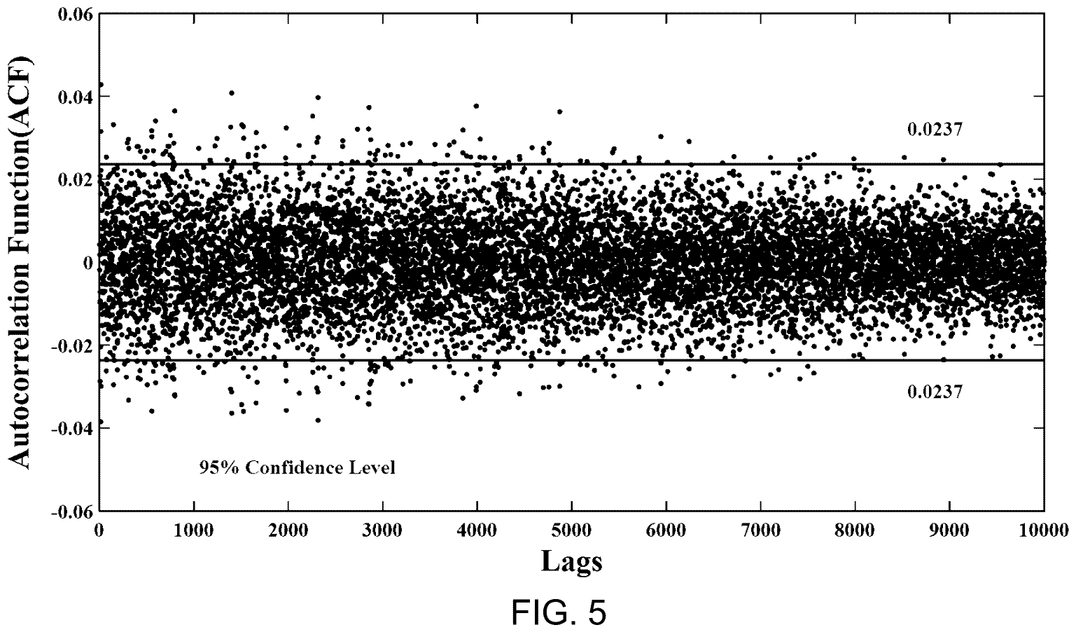

The autocorrelation function (ACF) describes the degree of correlation between a current value and a past value of a random response sequence. If the ACF value is 0, it indicates that a generated response sequence does not have a spatial correlation. An ACF test is performed on 10,000 responses of the timing-violation software physical unclonable function circuit provided by the invention, and the test result is shown in FIG. 5. The test result shown in FIG. 5 indicates that within the confidence interval of 95%, the ACF value of the timing-violation software physical unclonable function circuit provided by the invention is 0.0237, which is close to an ideal value 0.

### (3) Uniqueness and Reliability

The uniqueness of PUFs is evaluated by the Inter-Hamming distance (Inter-HD), that is, the uniqueness of PUFs is evaluated by an average HD between responses generated by applying the same challenge to different PUFs. In an ideal condition, the average HD is 50%. The average HD is calculated by:

$$U = \frac{2}{k ( k - 1 )} {\sum }_{p = 1}^{k - 1} {\sum }_{q = p + 1}^{k} \frac{HD ( {R}_{p} , {R}_{q} )}{r} \times 100 \% \qquad ( 1 )$$

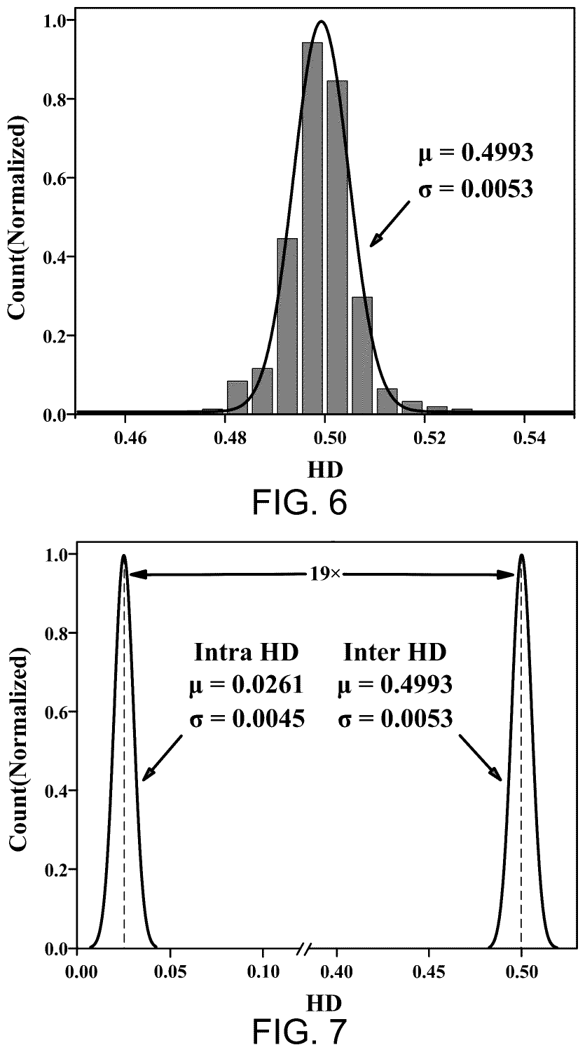

When the average Inter-HD is calculated, k indicates the number of the PUFs, Rₚ and R_{q} respectively indicate output responses of a p^{th} PUF and a q^{th} PUF under the same challenge, r indicates the number of bits of responses, and HD (Rₚ, R_{q}) is the HD of output responses. By changing the layout and using different development boards, a same group of input challenge signals are applied to 30 different timing-violation software physical unclonable function circuits according to the invention, and the Inter-HD of PUF responses of the timing-violation software physical unclonable function circuits is calculated, and analyzed as shown in FIG. 6. It may be known, by analyzing FIG. 6, that the average Inter-HD of the timing-violation software physical unclonable function circuit provided by the invention is 49.93% and the variance is 0.53%, indicating that the timing-violation software physical unclonable function circuit provided by the invention has good uniqueness.

The reliability of PUFs reflects the capacity to keep responses consistent of the PUFs under the same challenge and is evaluated by an average Intra-Hamming distance (Intra-HD) of responses obtained by repeatedly applying the same challenge to the same PUF k times. Under an ideal condition, the average Intra-HD is 0%. When the average Intra-HD is calculated, k indicates the repeat times. The same challenge signal is applied to the same timing-violation software physical unclonable function circuit provided by the invention 50 times, and the Intra-HD of PUF response data of the timing-violation software physical unclonable function circuit is calculated and analyzed. The average Intra-HD of the timing-violation software physical unclonable function circuit provided by the invention is 2.61% and the variance is 0.45%, indicating that the timing-violation software physical unclonable function circuit provided by the invention has good reliability. Normalized results of the Inter-HD and Intra-HD are shown in FIG. 7, which visually reflects that the timing-violation software physical unclonable function circuit provided by the invention has good reliability and uniqueness.

### (4) Security

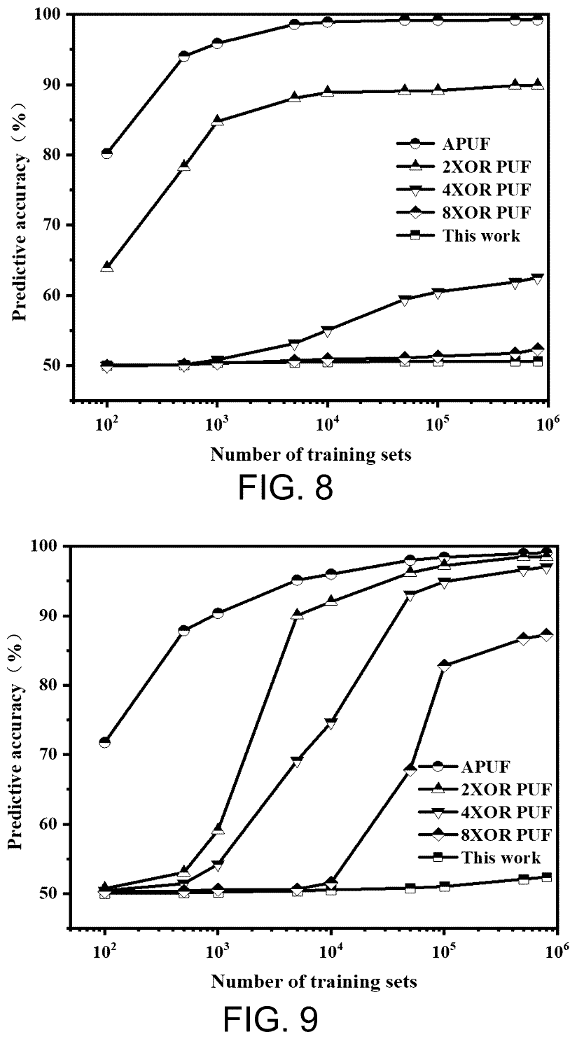

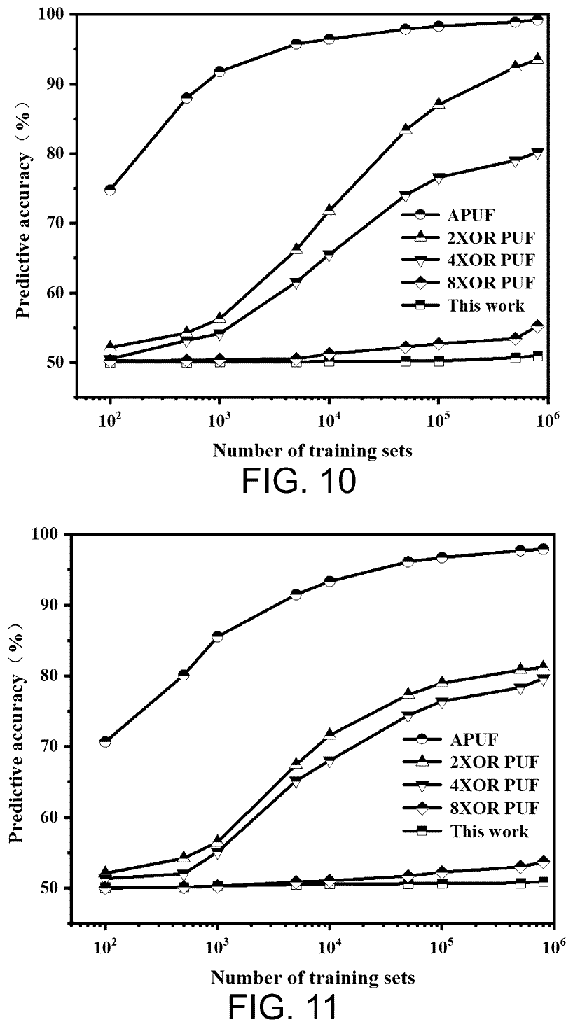

To evaluate the security of the timing-violation software physical unclonable function circuit provided by the invention, an APUF and three variants thereof 2XOR PUF, 4XOR PUF and 8XOR PUF are used as reference objects, each PUF generates 106 challenge-response pairs, and four machine learning (ML) algorithms are used to perform a Python modeling attack test on each PUF, wherein the attack algorithms are logistic regression (LR), a support vector machine (SVM), an artificial neural network (ANN) and a light gradient boosting machine (Light GBM), respectively. During training, the number of test sets is 200,000 and remains unchanged, and the number of training sets is gradually increased to 800,000. The predictive accuracy of different algorithms to five PUFs under different data sets is calculated. FIG. 8 reflects the predictive accuracy in a case where the attack algorithm is the LR, FIG. 9 reflects the predictive accuracy in a case where the attack algorithm is the ANN, FIG. 10 reflects the predictive accuracy in a case where the attack algorithm is the SVM, and FIG. 11 reflects the predictive accuracy in a case where attack algorithm is the Light GBM. The results illustrated by FIGS. 8-11 indicate that the timing-violation software physical unclonable function circuit according to the invention has good anti-attack capacity to the four ML algorithm, further indicating that the invention has better security.

### (5) Performance Comparison

Performance comparison of the timing-violation software physical unclonable function circuit provided by the invention and four different software PUFs is shown in Table 2.

TABLE 2
Performance comparison of different software PUFs

| | | | | | Predictive accuracy of | | | |
|---|---|---|---|---|---|---|---|---|
| | | Randomness | Uniqueness | Reliability | ML attacks (%) | | | |
| Literature | Process | (%) | (%) | (%) | LR | ANN | SVM | LightGBM |
| 1 | 65 nm | NIST | 50.01 | — | — | — | — | — |
| | ASIC | | | | | | | |
| 2 | 65 nm | 49.68 | 47.58 | — | 61.21 | — | — | — |
| | ASIC | | | | | | | |
| 3 | 45 nm | 48.50 | 40.31 | 85.67 | — | — | — | — |
| | ASIC | | | | | | | |
| 4 | 90 nm | — | 38.7 | 97.2 | — | — | — | — |
| | FPGA | | | | | | | |
| The | 28 nm | NIST | 49.93 | 97.39 | 50.61 | 52.37 | 50.98 | 50.91 |
| invention | FPGA | | | | | | | |

In Table 2, Literature 1 is “J. Chen, P. Wang, Y. Zhang, and H. Zhang,” SPUF design based on Camellia encryption algorithm,” Microelectronics Journal, Vol. 112, 2021″, Literature 2 is “WANG Pengjun, CHEN Jia, ZHANG Yuejun, et al “Software PUF with multiple entropy sources based on path sensitization,” Journal of Xidian University, Vol. 49 (06), pp. 58-66, 2022″, Literature 3 is “A. Japa, J. Zhang, W. Liu, and C. Gu, “Processor based Intrinsic PUF Design for Approximate Computing: Faith or Reality,” in 2023 Asian Hardware Oriented Security and Trust Symposium (Asian HOST), Tianjin, China, pp. 1-6, 2023″, and Literature 4 is “A. Maiti and P. Schaumont, “A novel microprocessor-intrinsic Physical Unclonable Function,” in 22nd International Conference on Field Programmable Logic and Applications (FPL), pp. 380-387, 2012”. It may be known, by analyzing data in Table 2, that compared with four other existing different software PUFs, the timing-violation software physical unclonable function circuit provided by the invention has better reliability and security.

To sum up, the timing-violation software physical unclonable function circuit completely adopts an existing combinatorial logic pipeline architecture using a carry lookahead adder as an arithmetic operation cell as a hardware platform no any other hardware circuit needs to be additionally designed and added, and PUF responses capable of representing hardware characteristics may be extracted by increasing the clock frequency of the existing combinatorial logic pipeline architecture. Compared with existing software PUF products, the timing-violation software physical unclonable function circuit has higher security, lower hardware overheads, higher working efficiency and better reliability and uniqueness and avoids the waste of hardware resources.

What is claimed is:

1. A timing-violation software physical unclonable function circuit, comprising:
a combinatorial logic pipeline architecture which serves as a hardware platform, wherein the combinatorial logic pipeline architecture includes an arithmetic operation cell, and the arithmetic operation cell includes a carry lookahead adder for performing add operations
wherein the timing-violation software physical unclonable function (PUF) circuit generates PUF response outputs by triggering timing violations in the combinatorial logic pipeline architecture.

2. The timing-violation software physical unclonable function circuit according to claim 1, wherein the combinatorial logic pipeline architecture further includes an input register cell and a sampling register cell;
wherein the carry lookahead adder included in the arithmetic operation cell is an m-bit carry lookahead adder, and the m-bit carry lookahead adder has two m-bit addend input ports and a (m+1)-bit addend sum output port;
the input register cell is formed by 2 m D flip-flops, each D flip-flop has a signal input port, a signal output port and a clock control port, the signal input ports of the 2 m D flip-flops are used as a 2 m-bit challenge input port of the input register cell, the signal output ports of the 2 m D flip-flops are used as a 2 m-bit output port of the input register cell, the clock control ports of the 2 m D flip-flops are connected, and a connecting terminal is a clock control port of the input register cell;
the sampling register cell is formed by (m+1) D flip-flops, each D flip-flop has a signal input port, a signal output port and a clock control port, the signal input ports of the (m+1) D flip-flops are used as a (m+1)-bit input port of the sampling register cell, the signal output ports of the (m+1) D flip-flops are used as a (m+1)-bit output port of the sampling register cell, the clock control ports of the (m+1) D flip-flops are connected, and a connecting terminal is a clock control port of the sampling register cell; and the 2 m-bit output port of the input register cell is correspondingly bit addend sum output port of the m-bit carry lookahead adder is connected to the (m+1)-bit input port of the sampling register cell;
in response to that the timing-violation software physical unclonable function circuit needs to generate a PUF response, a 2 m-bit challenge signal is input to the 2 m-bit challenge input port of the input register cell, and a clock signal lasting for two cycles is synchronously input to the time control port of the input register cell and the clock control port of the sampling register cell, wherein the cycle of the clock signal is 0.5 Tₘₐₓ, and Tₘₐₓ is a maximum path delay time from the 2 m-bit challenge input port of the input register cell to the (m+1)-bit output port of the sampling register cell;
at the arrival of a first rising edge of the clock signal, the input register cell, under the control of the clock signal, outputs the 2 m-bit challenge signal input thereto to the two m-bit addend input ports of the m-bit carry lookahead adder by means of the 2 m-bit output port thereof, and the m-bit carry lookahead adder performs an add operation on two m-bit challenge signals input to the two m-bit addend input ports thereof to obtain an (m+1)-bit operation result, which is output to the (m+1)-bit input port of the sampling register cell by means of the (m+1)-bit addend sum output port of the m-bit carry lookahead adder; then, at the arrival of a second rising edge of the clock signal, the sampling register cell, under the control of the clock signal, performs sampling on the (m+1)-bit operation result input to the (m+1)-bit input port thereof; at this moment, because the cycle of the clock signal is too small, a timing violation happens to part of the flip-flops in the sampling register cell, and the flip-flops subjected to the timing violation randomly output 0 or 1 by means of the signal output ports thereof, such that an abnormal (m+1)-bit operation result is output by the (m+1)-bit output port of the sampling register cell and used as an initial PUF response of a software PUF;
the most significant bit of a theoretical operation result obtained by performing an add operation on the two m-bit challenge signals input to the two m-bit addend input ports of the m-bit carry lookahead adder is abandoned to obtain an m-bit reference value, the most significant bit of the initial PUF response is abandoned to obtain m-bit data, and different bits between the m-bit data and the m-reference value are counted;
if the counting result is an odd number, a final PUF response of the timing-violation software physical unclonable function circuit is 1; otherwise, the final PUF response of the timing-violation software physical unclonable function circuit is 0.
